(19) United States
(12) Patent Application Publication
(10) Pub. No.: US 2025/0168935 A1
(43) Pub. Date: May 22, 2025

(54) Non-Glove Heater

(71) Applicant: Kevin Chapple, West Fargo, ND (US)

(72) Inventor: Kevin Chapple, West Fargo, ND (US)

(21) Appl. No.: 18/946,431

(22) Filed: Nov. 13, 2024

Related U.S. Application Data
(60) Provisional application No. 63/600,617, filed on Nov. 17, 2023.

(51) Int. Cl. H05B 3/34; H05B 1/02

(52) U.S. Cl. CPC H05B 3/34; H05B 1/0252

(57) ABSTRACT

A non-glove heater system includes an electrical heating system; and a multiple of heating clements powered by the electrical heating system, cach of the multiple of heating elements are positioned upon a wearer's nail.

### CROSS REFERENCE TO RELATED APPLICATION[S]

The present disclosure claims priority to U.S. Provisional Patent Disclosure Ser. No. 63/600,617, filed Nov. 17, 2023.

### BACKGROUND

The present disclosure relates to a hand warmer system, and more specifically to heating elements which are positioned upon a wearer's nails to provide warmth to a wearer's hand or foot.

Auxiliary heat is often provided within certain garments that will be used in cold weather environments, such as work, sport, or other settings. For example, skiers have long used hand warmers based on chemical reactions between reactants such as iron, activated carbon, and water. Other glove manufacturers have added electrical heating features to gloves, such as those that are based on some rechargeable battery technology.

An issue with existing heated clothing is sufficient warmth as well as gloved dexterity to perform working tasks, such as picking up and holding smaller items (e.g., screws and nuts) or connecting hoses and wires.

### SUMMARY

A non-glove heater system according to one disclosed non-limiting embodiment of the present disclosure includes an electrical heating system; and a multiple of heating elements powered by the electrical heating system, each of the multiple of heating elements are positioned upon a wearer's nail.

A further embodiment of any of the foregoing embodiments of the present disclosure includes that the electrical heating system comprises a power source to power the multiple of heating elements.

A further embodiment of any of the foregoing embodiments of the present disclosure includes a wiring harness to interconnect the electrical heating system to the multiple of heating elements.

A further embodiment of any of the foregoing embodiments of the present disclosure includes that the wiring harness extends at least partially along an outer surface of a glove.

A further embodiment of any of the foregoing embodiments of the present disclosure includes that the electrical heating system is contained within a wrist band.

A further embodiment of any of the foregoing embodiments of the present disclosure includes that a control is contained within a wrist band.

A further embodiment of any of the foregoing embodiments of the present disclosure includes that each of the multiple of heating elements comprise an adhesive to attach to the wearer's nail.

A further embodiment of any of the foregoing embodiments of the present disclosure includes that each of the multiple of heating elements are operable to emit a frequency via the wearer's nail.

A further embodiment of any of the foregoing embodiments of the present disclosure includes that each of the multiple of heating elements are operable to receive a frequency via the wearer's nail.

A further embodiment of any of the foregoing embodiments of the present disclosure includes that each of the multiple of heating elements generate heat between 72-121 degrees Fahrenheit.

A further embodiment of any of the foregoing embodiments of the present disclosure includes that each of the multiple of heating elements generate heat at about 91 degrees Fahrenheit.

A non-glove heater according to one disclosed non-limiting embodiment of the present disclosure includes an electrical heating system; and a multiple of heating elements powered by the electrical heating system to generate heat between 72-121 degrees Fahrenheit; and an adhesive attached to each of the multiple of heating elements to attach each of the multiple of heating elements to a respective one of a wearer's nail.

A further embodiment of any of the foregoing embodiments of the present disclosure includes that the electrical heating system comprises a power source to power the multiple of heating elements.

A further embodiment of any of the foregoing embodiments of the present disclosure includes a wiring harness to interconnect the electrical heating system to the multiple of heating elements.

A further embodiment of any of the foregoing embodiments of the present disclosure includes that a wiring harness extends at least partially along an outer surface of a glove.

A further embodiment of any of the foregoing embodiments of the present disclosure includes that the electrical heating system is contained within a wrist band.

A further embodiment of any of the foregoing embodiments of the present disclosure includes that the electrical heating system is operable to adjust a temperature of each of the multiple of heating elements.

A further embodiment of any of the foregoing embodiments of the present disclosure includes an indicator contained within a wristband to indicate a temperature of each of the multiple of heating elements

A further embodiment of any of the foregoing embodiments of the present disclosure includes that each of the multiple of heating elements are arranged in a sinusoidal pattern.

The foregoing features and elements may be combined in various combinations without exclusivity, unless expressly indicated otherwise. These features and elements as well as the operation thereof will become more apparent in light of the following description and the accompanying drawings. It should be appreciated that however the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a schematic view of a non-glove heater according to one disclosed non-limiting embodiment.

FIG. 2 is a schematic view of a hand heater according to another disclosed non-limiting embodiment.

FIG. 3 is a schematic view of a heating element of the non-glove heater, each of which is sized to a wearer's nail.

FIG. 4 is a perspective view of a non-glove heater according to another disclosed non-limiting embodiment.

### DETAILED DESCRIPTION

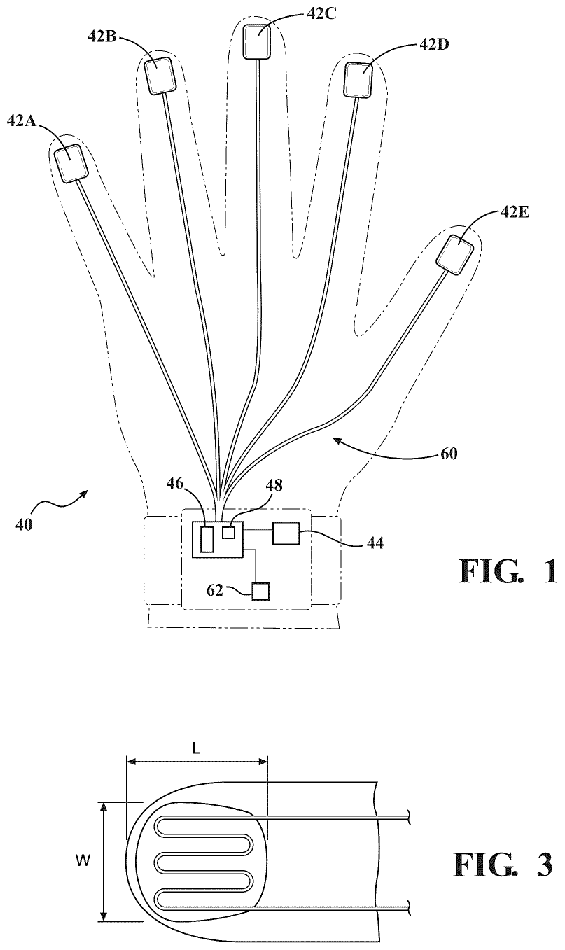

FIG. 1 schematically illustrates a non-glove heater 20 that generally includes an electrical heating system 40 with a multiple of heating elements 42A-42E, each of which are positioned adjacent to a wearer's nail, e.g., fingernail, toenail, to provide heat to a user's hand, foot.

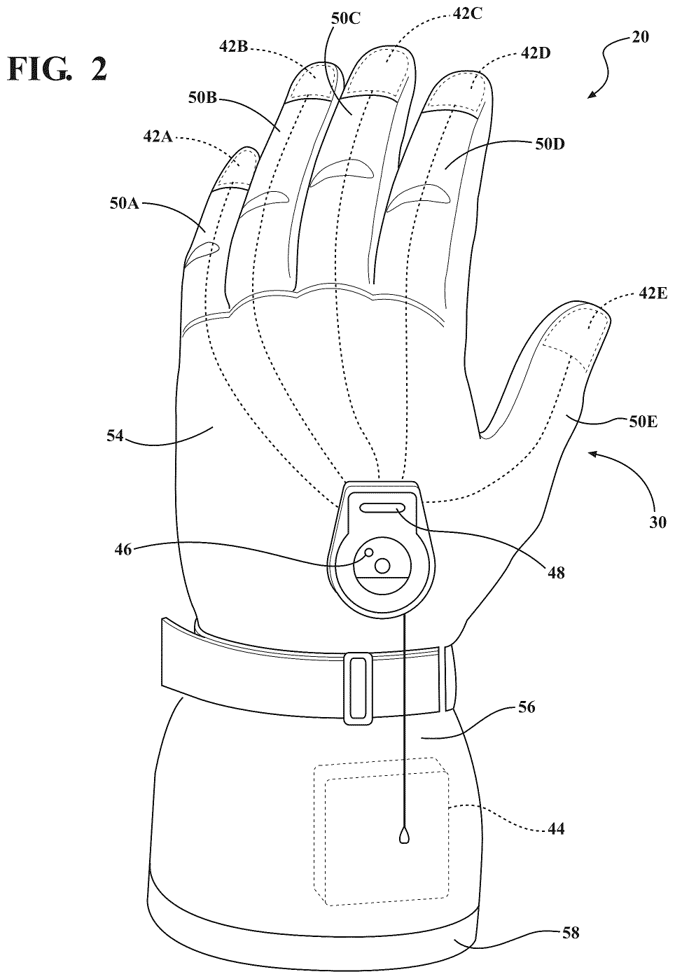

The multiple of heating elements 42A-42E may fit onto or over a tip of the wearer's fingers, toes. Alternatively, in another embodiment, the multiple of heating elements 42A-42E may be incorporated into a glove 30 (FIG. 2), and portions of the electrical heating system 40 may be incorporated into a wristband, a sleeve of a jacket, a mitten, a sock, or other such support member.

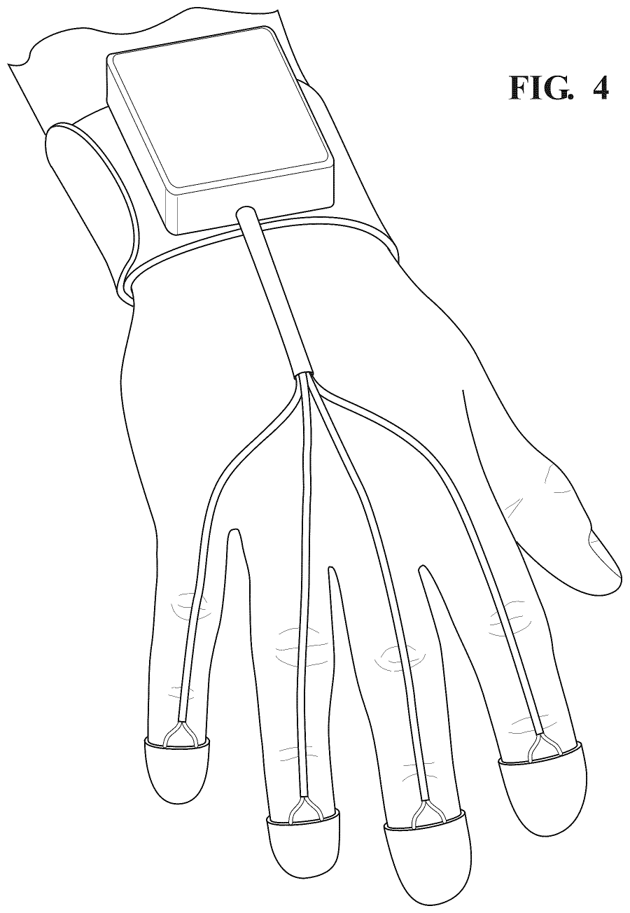

Alternatively, in another embodiment, the multiple of heating elements 42A-42E may be attached to the wearer's nails (FIG. 3) via an adhesive, a tape, an elastic band, or other direct attachment (FIG. 4). The attachment, for example, may be a form of double-stick tape or adhesive.

The electrical heating system 40 for the multiple of heating elements 42A-42E may generally include a power source 44, a control 46, and an indicator 48 which may be contained within a wristband 70, the glove 30 (FIG. 2), a sleeve of a jacket, or other such support member. The power source 44 may be a replaceable and/or rechargeable battery and may include various connection interfaces. The power source 44 may be selectively operable by the control 46 which can be utilized to adjust the intensity of the heat generated by the multiple of heating elements 42A-42E either individually or as a group. The control 46 may include wired Bluetooth, RF, etc. type control. The indicator 48 may be LED, number, color, etc., to indicate the intensity.

A wiring harness 60 may interconnect the multiple of heating elements 42A-42E, the power source 44, the control 46 and the indicator 48 with other components such as a charge port 62, etc. The charge port may alternatively include an inductive charger pad or other interface. In one embodiment, the wiring harness 60 may include flat flexible cable such as that made up of flat tin or gold-plated copper conductors insulated with Polyester or Polyimide tapes.

The heating elements 42A-42E may include, for example, one or more conductive wires or filaments with an electrical resistance through which an electric current travels, driven by the power source 44. The one or more conductive wires or filaments may be of a material such as, for example, copper, coated carbon steel, graphite, etc. The conductive wire or filament may be, for example, in a serpentine pattern sized with respect to a wearer's nail. Heating elements may, for example, include a material arranged in a sinusoidal-wave shape pattern.

The conductive wire or filament may have, for example, a resistance in the range of 0.5-10.0 ohm. The non-glove heater 20 may be capable of producing a temperature change at the heating elements 42A-42E of, for example, 4-18 degrees Fahrenheit over a 30 second time period. The heating elements 42A-42E may be operated in a continuous or intermittent manner. In one embodiment, the heating elements 42A-42E generate heat between 72-121 degrees Fahrenheit and more specifically at about 91 degrees Fahrenheit. In another embodiment, 121 degrees Fahrenheit may be sufficient to degrade the adhesive used in Nail Salons; which facilitates the chemical-free removal of artificial nails or other acrylic-style cosmetic or stick-on nails.

With reference to FIG. 2, in one embodiment, the multiple of heating elements 42A-42E may be located within a finger appendage 50A-50E of the glove 30. The glove 30 may further include a palm 52, a back of the hand 54, a cuff 56 and a sleeve 58. The glove 30 may be, for example, much thinner as minimal insulation need be provided, and the glove may be primarily utilized to retain the multiple of heating elements 42A-42E and/or the electrical heating system 40. Although particular parts are described in the illustrated embodiment, other parts/sections may alternatively or additionally be provided based in part, for example, on the type of glove, e.g., skiing, work, underwater, space, waterproof, etc. The glove 30 may be manufactured of various materials and combinations thereof such as leather, fabric, Acrylic, Polyester, cotton, latex, Nitrile, Neoprene, Polyurethane, etc.

With reference to FIG. 3, the relatively small heating elements 42A-42E may be sized to the nail bed of particular users. The distal end of each finger is protected by a strong plate of hard keratin, called a nail or nail plate, which grows out from a nail bed. The nail bed is a specialized form of skin epithelium and has the same four layers of the epidermis of skin, with the nail plate being analogous to the stratum corneum layer. Applicant has determined that warming the wearer's nails/nail beds provides warmth to the entire hand and improves the dexterity thereof as larger heat pads have heretofore limited the flexibly of gloves. The width (W) may be the greatest transverse distance between the two lowest points of the nail in the lateral nail groove while the length (L) was defined as the greatest longitudinal length between the tip of the finger and the groove at the junction of the proximal nail fold and eponychium. In some embodiments, each of the multiple of heating elements 42A-42E may be 10-15 mm in length (L) and 5-20 mm in width (W) (FIG. 3), more specifically, 7 mm in length by 4 mm in width. That is, the heating elements 42A-42E may be sized to the wearer, small, medium large, man, women, child, etc. The heating elements 42A-42E may be, for example, nail shaped as shown in FIG. 3, circular, rectangular, etc.

With reference to FIG. 4, the wiring harness 60 may include elastic features that allow the wiring harness 60 to follow the length of the finger but extend and retract as the finger is posed. The wiring harness 60 may be of a length that is less than that of respective finger to closely follow along the top of the finger and elastically extend and retract therewith so the wires do not become tangled or otherwise snagged in use. Other embodiments may include individual heating elements with wireless-control technology.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be appreciated that within the scope of the appended claims, the disclosure may be practiced other than as specifically described. For that reason the appended claims should be studied to determine true scope and content.

What is claimed is:

1. A non-glove heater, comprising:
an electrical heating system; and
a multiple of heating elements powered by the electrical heating system, each of the multiple of heating elements are positioned upon a wearer's nail.

2. The non-glove heater as recited in claim 1, wherein the electrical heating system comprises a power source to power the multiple of heating elements.

3. The non-glove heater as recited in claim 2, further comprising a wiring harness to interconnect the electrical heating system to the multiple of heating elements.

4. The non-glove heater as recited in claim 3, wherein the wiring harness extends at least partially along an outer surface of a glove.

5. The non-glove heater as recited in claim 3, wherein the electrical heating system is contained within a wrist band.

6. The non-glove heater as recited in claim 5, wherein a control is contained within a wrist band.

7. The non-glove heater as recited in claim 1, wherein each of the multiple of heating elements comprise an adhesive to attach to the wearer's nail.

8. The non-glove heater as recited in claim 1, wherein each of the multiple of heating elements are operable to emit a frequency via the wearer's nail.

9. The non-glove heater as recited in claim 1, wherein each of the multiple of heating elements are operable to receive a frequency via the wearer's nail.

10. The non-glove heater as recited in claim 1, wherein each of the multiple of heating elements generate heat between 72-121 degrees Fahrenheit.

11. The non-glove heater as recited in claim 1, wherein each of the multiple of heating elements generate heat at about 91 degrees Fahrenheit.

12. A non-glove heater, comprising:
an electrical heating system; and
a multiple of heating elements powered by the electrical heating system to generate heat between 72-121 degrees Fahrenheit; and
an adhesive attached to each of the multiple of heating elements to attach each of the multiple of heating elements to a respective one of a wearer's nail.

13. The non-glove heater as recited in claim 12, wherein the electrical heating system comprises a power source to power the multiple of heating elements.

14. The non-glove heater as recited in claim 13, further comprising a wiring harness to interconnect the electrical heating system to the multiple of heating elements.

15. The non-glove heater as recited in claim 13, wherein a wiring harness extends at least partially along an outer surface of a glove.

16. The non-glove heater as recited in claim 13, wherein the electrical heating system is contained within a wrist band.

17. The non-glove heater as recited in claim 16, wherein the electrical heating system is operable to adjust a temperature of each of the multiple of heating elements.

18. The non-glove heater as recited in claim 17, further comprising an indicator contained within a wristband to indicate a temperature of each of the multiple of heating elements.

19. The non-glove heater as recited in claim 18, wherein each of the multiple of heating elements are arranged in a sinusoidal pattern.
